(19) United States
(12) Patent Application Publication
(10) Pub. No.: US 2008/0126729 A1
(43) Pub. Date: May 29, 2008

(54) SYSTEMS AND METHODS FOR CONTROLLING ACCESS BY A THIRD PARTY TO A PATIENT'S MEDICAL RECORDS ON A MEDICAL INFORMATION CARD

(76) Inventors: Yigang Cai, Naperville, IL (US); Suzann Hua, Lisle, IL (US)

Correspondence Address: DUFT BORNSEN & FISHMAN, LLP, 1526 SPRUCE STREET, SUITE 302, BOULDER, CO, 80302, US

(21) Appl. No.: 11/563,944

(22) Filed: Nov. 28, 2006

(51) Int. Cl. G06F 12/00; G06F 17/30

(52) U.S. Cl. 711/164; 707/9; 707/E17.008; 711/E12.091

(57) ABSTRACT

Systems and method for storing information of a user within a medical information card and for controlling access to the information by a third party. The medical information card comprises a storage medium adapted to store the medical records of the patient. The medical information card further comprises a processing system coupled to the storage medium adapted to receive a request for access to the medical records by the third party and to determine a subset of the medical records that the third party is authorized to access based on the request. The medical information card further comprises an interface system coupled to the processing system adapted to exchange the subset of the medical records with the external data system of the third party in response to authenticating the request.

### FIELD OF THE INVENTION

The invention relates generally to the field of storage devices and, in particular, to methods and systems for controlling access by a third party to medical records of a patient stored in a portable storage device.

### STATEMENT OF THE PROBLEM

Clients often visit multiple professionals (e.g., doctors, lawyers and accountants) seeking professional services regarding a particular problem or issue. Often times, these professionals desire to see information regarding the client's visits with a previous professional. For example, a patient may visit a family doctor regarding a heart problem. If the patient's condition is beyond the scope of the doctor's expertise, then the patient may visit a heart specialist for further evaluation. It may be beneficial for the heart specialist to view medical records relating to the patient's visit with the family doctor, as well as other doctors that the patient may have visited in the past regarding the same condition. Problems arise in sharing a patient's medical records with multiple doctors and medical institutions.

In the United States, patient medical information must be protected with privacy controls to avoid disclosure of confidential patient information. Medical institutions and doctor's offices are not permitted to share a patient's medical information with other medical professionals. There is no common database available among medical institutions and doctors offices. As such, a patient's medical records may be scattered across multiple medical offices.

If a patient has previously visited a doctor regarding a medical problem and subsequently visits another doctor regarding the same medical problem, then the second doctor may have a need for the medical records regarding the patient's visits to the first doctor. In some situations, it may be possible for the second doctor to receive the patient's permission to retrieve the medical records from the first doctor. However, this may be time consuming and implausible under emergency situations.

It is a problem that doctors and medical professionals do not have immediate access to a patient's personal medical records generated by another doctor or medical institution.

### SUMMARY OF THE SOLUTION

This invention solves the above and other problems with systems and methods for controlling access by a third party to stored medical records and other personal information on a medical information card. Medical records are stored on a medical information card (e.g., a portable storage device with processing capabilities), which the patient may carry from one medical facility to another. This enables medical records from one doctor to be made available to another doctor without worrying about unauthorized access to the records. The patient may specify which medical records are to be shared and with whom the specified medical records may be shared.

One embodiment of the invention is a medical information card for storing medical records of a patient and for controlling access to the medical records by a third party having an external data system. The medical information card comprises a storage medium adapted to store the medical records of the patient. The medical information card further comprises a processing system coupled to the storage medium adapted to receive a request for access to the medical records by the third party and to determine a subset of the medical records that the third party is authorized to access based on the request. The medical information card further comprises an interface system coupled to the processing system adapted to exchange the subset of the medical records with the external data system of the third party in response to authenticating the request.

Another embodiment of the invention is a medical information card for storing medical records of a patient and for controlling access to the medical records by a third party having an external data system. The medical information card comprises a storage medium adapted to store the medical records of the patient. The medical information card further comprises a processing system coupled to the storage medium, the processing system adapted to receive a request from the patient for access by the third party to the medical records, wherein the request comprises access information of the patient. The access information is used by the patient to access the medical records and to authorize third parties to access the medical records. The processing system is further adapted to authenticate the patient based on the access information and to determine a subset of the medical records that the third party is authorized to access based on the request. The medical information card further comprises an interface system coupled to the processing system adapted to transmit the subset of the medical records to the external data system of the third party in response to authorizing the third party.

Another embodiment of the invention is a method for managing access to a patient's medical records by a third party having an external data system. The method comprises storing the medical records of the patient in a portable storage device. The method further comprises receiving a request from the patient for access by the third party to the medical records. The request comprises access information. The method further comprises authenticating the patient based on the access information. The method further comprises determining a subset of the medical records that the third party is authorized to access based on the request. The method further comprises transmitting the subset of the medical records to the external data system of the third party.

The invention may include other exemplary embodiments described below.

### DESCRIPTION OF THE DRAWINGS

The same reference number represents the same or similar element on all drawings.

FIG. 1 illustrates a system for storing medical records of a patient on a portable storage device and for controlling access to the medical records in an exemplary embodiment of the invention.

FIG. 2 illustrates a medical facility for retrieving medical records of a patient on a portable storage device and for controlling access to the medical records in an exemplary embodiment of the invention.

FIG. 3 illustrates a medical information card for managing access to a patient's medical records in an exemplary embodiment of the invention.

FIG. 4 illustrates a method for managing access to a patient's medical records in an exemplary embodiment of the invention.

FIG. 5 illustrates a method for identifying medical records to be provided to an external data system in an exemplary embodiment of the invention.

FIG. 6 illustrates a method for exchanging medical records with an external data system in exemplary embodiment of the invention.

### DETAILED DESCRIPTION OF THE INVENTION

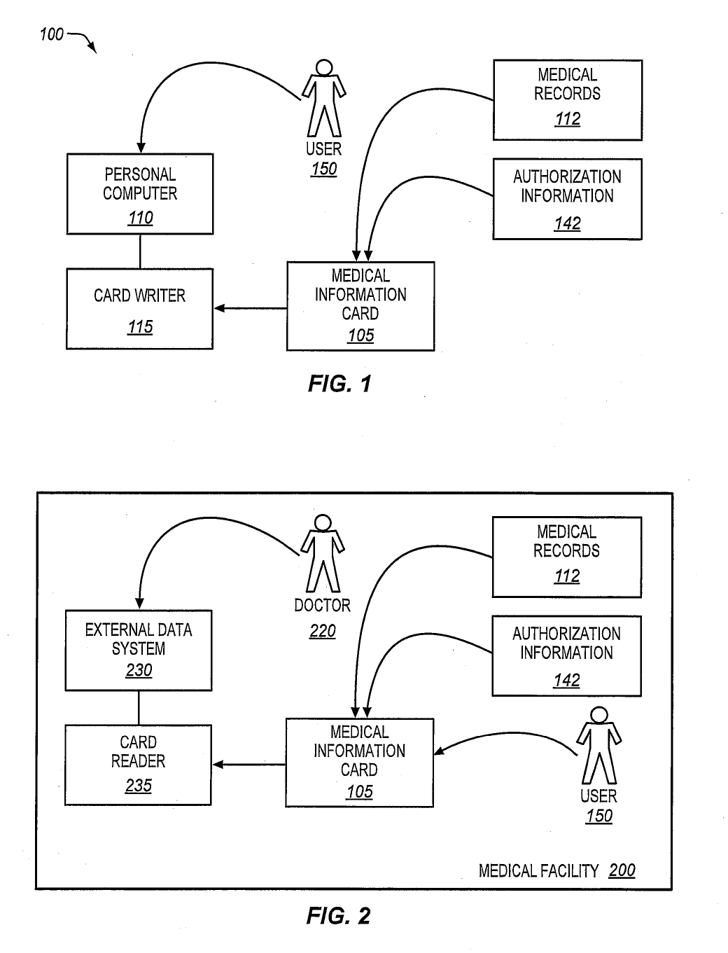

FIGS. 1-6 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

A patient may acquire a medical information card for storing and transporting medical records from one medical facility to another facility. This allows the patient to transfer their medical records easily from one doctor to another while controlling access to the medical records. For example, the patient may provide medical records from their family doctor relating to a heart condition to a heart specialist. At the same time, the patient may shield medical records relating to a recent eye exam stored on the medical information card from the heart specialist. The patient may carry around their entire medical history in the medical information card, and may share only selected portions of the medical records with particular doctors.

FIG. 1 illustrates an exemplary system 100 for setting up a medical information card 105 for storing medical records 112 in an exemplary embodiment of the invention. Patient 150 inserts medical information card 105 into card writer 115 attached to personal computer 110. Card writer 115 may be any type of memory card writer and/or reader adapted for accessing and storing information on medical information card 105. Personal computer 110 may be any suitable data processing system. Using personal computer 110 and card writer 115, patient 150 configures authorization information 142 (e.g., a password) on medical information card 105. Authorization information 142 allows patient 150 to control access to medical records 112 by requiring a password or another type of equivalent authentication credential. Authorization information 142 is used by medical information card 105 to authenticate patient 150. Patient 150 may initially store medical records 112 on medical information card 105. Medical records 112 initially stored on medical information card 105 may be information that a doctor has provided to patient 150.

FIG. 2 illustrates an exemplary medical facility 200 for retrieving medical records 112 from medical information card 105 in an exemplary embodiment of the invention. Medical facility 200 comprises an external data system 230 for retrieving medical records 112 from medical information card 105. External data system 230 may be a personal computer or any suitable data processing system that is adapted to download medical records 112 from medical information card 105 and upload medicals records 112 to medical information card 105. Further functionality of external data system 230 may include displaying and/or printing medical records 112 once acquired from medical information card 105. Using external data system 230, doctor 220 may access medical records 112 on medical information card 105. A special software application may operate on external data system 230 for retrieving medical records 112 from medical information card 105. Medical facility 200 further comprises a card reader 235 coupled to external data system 230. Card reader 230 is adapted to read and write medical information 105. Medical information card 105 may also communicate with external data system 230 through any type of wired or wireless connection.

To access medical records 112 stored on medical information card 105, patient 150 may insert medical information card 105 into card reader 235. Patient 150 may provide a request to medical information card 105 authorizing doctor 220 to access a portion of medical records 112. Patient 150 may then enter access information (e.g., a password) to external data system 230 or medical information card 105. Medical information card 105 or external data system 230 may compare the access information with authorization information 142 stored on medical information card 105 to authenticate patient 150. Once patient 150 is authenticated, then doctor 220 may be authorized to access medical records 112 on medical information card 105. Medical records 112 may be medical records stored by patient 150 or another doctor during a visit to another medical facility by patient 150.

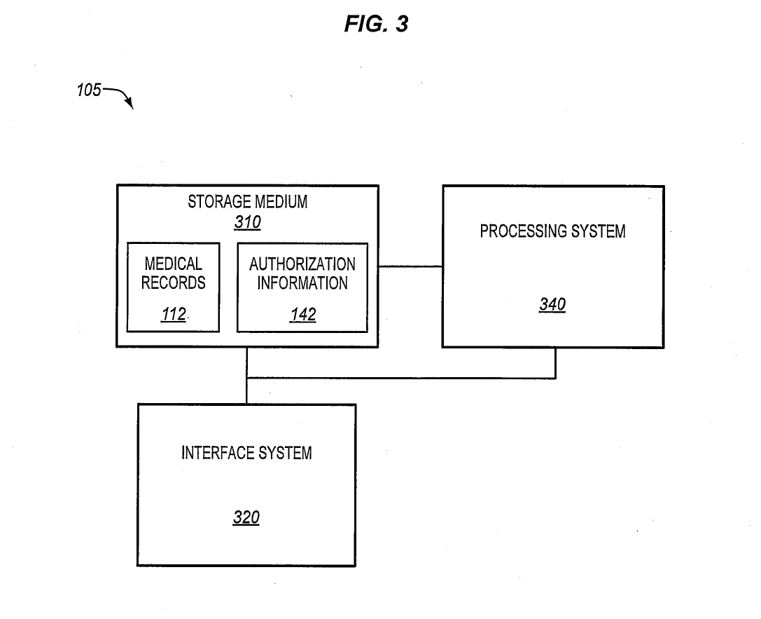

FIG. 3 illustrates medical information card 105 for storing medical records 112 of a patient 150 and for controlling access by a third party (e.g., doctor 220) to medical records 112 in an exemplary embodiment of the invention. Medical information card 105 may be appropriately embodied in a housing the size of a credit card or a smart card such that a patient may carry medical information card 105 to a hospital or medical facility 220. Medical information card 105 comprises a storage medium 310 adapted to store medical records 112. Each of medical records 112 may store data on a particular doctor (e.g., doctor 220) generating the medical record, a date of the medical record, a type of organ relating to the medical record, an affliction of the patient, etc., used to search medical records 112. Thus, a subset of medical records 112 may be selected and provided to doctor 220 or another medical professional rather than providing doctor 220 with all of medical records 112. Input from patient 150 may further specify criteria used to select the subset of medical records 112.

Medical information card 105 further comprises a processing system 340 coupled to storage medium 310 adapted to receive a request for access to a subset of the medical records 112 by the third party (e.g., doctor 220) and to authenticate the request. Processing system 340 retrieves authorization information 142 of patient 150 from storage medium 310. Authorization information 142 is used to authenticate patient 150 and to authorize doctor 220 to access medical records 112 through external data system 230.

Processing system 340 may be adapted to select a subset of medical records 112 for transmission to external data system 230 based upon an input (e.g., category) from the patient or the third party. Thus, if the input specifies a category, such as an organ (e.g., kidney), then processing system 340 may select medical records 112 relating to the patient's kidneys. Medical information card 105 further comprises interface system 320 coupled to processing system 340 to exchange medical records 112 with external data system 230.

Assume that patient 150 stores medical records 112 from one or more medical facilities 200 on storage medium 310 during visits with several doctors. Medical records 112 may comprise information relating to a kidney problem from a recent visit with a doctor. Subsequently, patient 150 may decide to visit another doctor regarding the same affliction, and the other doctor may desire to view the medical records 112.

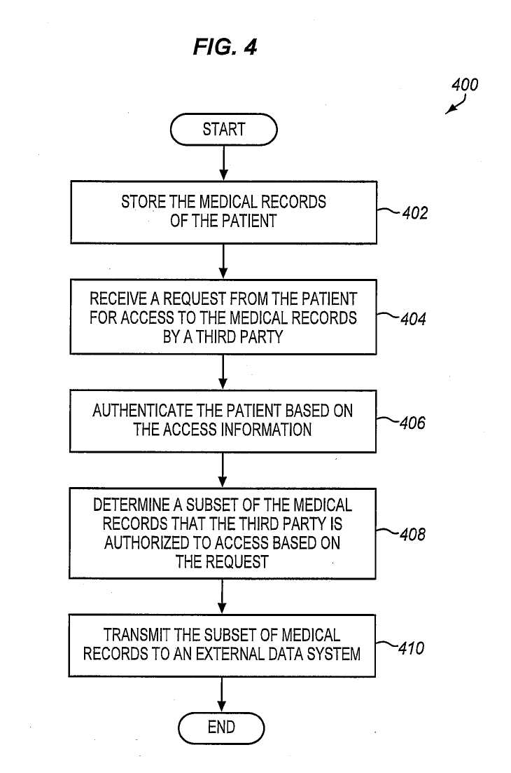

FIG. 4 illustrates a method 400 for managing access to a patient's medical records 112 in an exemplary embodiment of the invention. The steps of method 400 will be described with reference to medical information card 105 illustrated in FIGS. 2 and 3. The steps of method 400 are not all-inclusive, and may include other steps not shown.

In step 402, medical records 112 of the patient are stored on storage medium 310 of medical information card 105. During a visit with a doctor, the patient and/or doctor may store medical records 112 on medical information card 105. For easy searching and retrieval, medical records 112 may be stored in a database. A special format, such as XML, may be used for easy parsing and exchange of medical records 112.

In step 404, processing system 340 receives a request from the patient 150 for access by a third party (e.g., doctor 220) to a subset of medical records 112. The request may comprise access information of patient 150. Access information is a password or other type of authentication credential that the patient provides to medical information card 105 for authentication. The request may be a voice command from patient 150, or may be received by medical information card 105 from external data system 230. Patient 150 may enter the request at a keypad attached to external data system 230 or a keypad on or attached to medical information card 105. The request may further specify what types of records that the third party is authorized to access.

In step 406, processing system 340 authenticates patient 150 based on the access information. For authentication, patient 150 provides access information to processing system 340 seeking to authorize a third party to access medical records 112. For example, the patient may provide a pin number, a voiceprint sample, a fingerprint sample, etc. Processing system 340 may store authorization information 142, such as a pin number, voiceprint sample, fingerprint sample, etc., of the patient for comparison with the access information provided by patient 150. If patient 150 is not properly authenticated, then the third party may be denied access to medical records 112 in step 406. Otherwise, if patient 150 is properly authenticated, then the third party is allowed access to medical records 112 in step 408.

In step 408, processing system 340 determines a subset of the medical records 112 that the third party (e.g., doctor 220) is authorized to access based on the request. For example, the request may specify the subset of the medical records 112 that the third party is entitled to access. Alternatively, processing system 340 may determine the subset of the medical records 112 based on information in the request (e.g., what the third party wants to see or what the patient will allow the third party to see).

For example, the request may specify a particular organ, such as “heart”, or a particular affliction, such as “heart attack”. Processing system 340 then retrieves records related to “heart” or “heart attack”. The “heart” records are then transmitted to the external data system 230. Likewise, the request may further specify dates, and/or doctors associated with medical records 112. Processing system 340 may further narrow the retrieval to “heart” records matching the specified date and/or doctor. Thus, the subset of medical records 112 may not include all of medical records 112 stored on medical information card 105.

In step 410, interface system 320 transmits the subset of the medical records 112 to external data system 230. External data system 230 then displays the subset of the medical records 112 to doctor 220. Interface system 320 may additionally be adapted to download updated medical records 112 from external data system 230, as well as saving new medical records 112 provided by external data system 230.

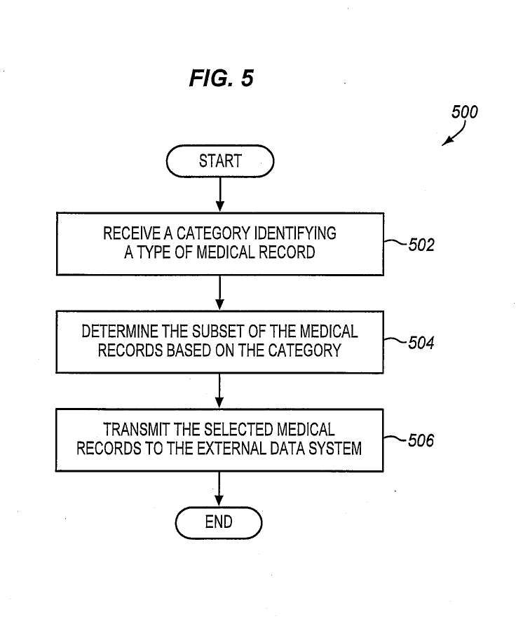

FIG. 5 illustrates a method 500 for identifying medical records to be provided to an external data system in an exemplary embodiment of the invention. The steps of method 500 will be described with reference to medical information card 105 illustrated in FIGS. 2 and 3. The steps of method 500 are not all-inclusive, and may include other steps not shown.

In step 502, processing system 340 receives input requesting a category of medical records 112 to be provided to the third party. Categories may be based on organs, dates, afflictions, doctors generating the record, etc. Exemplary organ categories may include cardiac, renal, or pulmonary. Thus, records relating to selected organs may be quickly accessed based on an organ type and a date of the information contained in the record. Patient 150 may input the category through a keypad of external data system 230, which transmits the category to medical information card 105. Further, the category may be entered as a voice command. For example, if the category of medical records 112 to be displayed is related to kidney problems, then patient 150 may speak “Please display records relating to kidney” into a microphone on medical information card 105. Medical information card 105 may recognize the content of the voice command and identify the category.

In step 504, processing system 340 determines a subset of the medical records 112 that the third party is authorized to access based on the category. In step 506, processing system 340 provides the selected subset of the medical records 112 to interface system 320 for transmission to external data system 230. Interface system 320 may comprise a wireless interface system, and medical records 112 may be transmitted to external data system 230 over a wireless connection, such as infrared, 802.11, or Bluetooth. Interface system 320 may also be a wired connection, such as a USB or Firewire port.

Medical information card 105 may be adapted for additional functionality in addition to transmitting medical records 112 to external data system 230. For example, if external data system 230 operates a special software application for accessing medical information card 105, then medical information card 105 may place restrictions on how external data system 230 uses medical records 112, as well as allowing external data system 230 to update medical records 112 on medical information card 105.

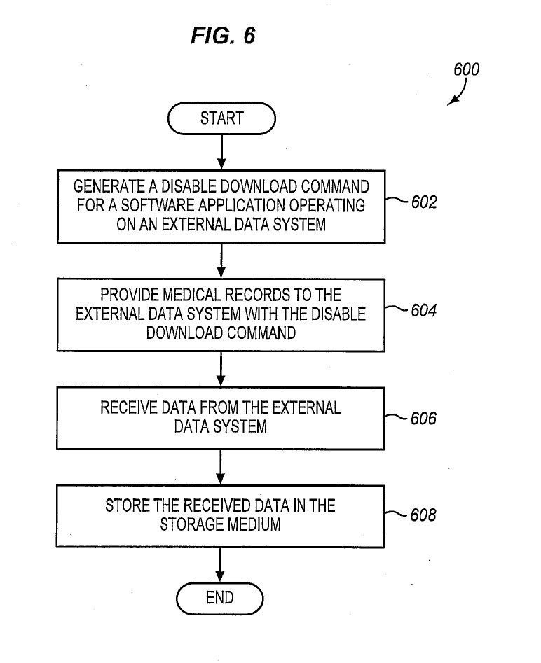

FIG. 6 illustrates a method 600 for exchanging medical records with an external data system in an exemplary embodiment of the invention. The steps of method 600 will be described with reference to medical information card 105 illustrated in FIGS. 2 and 3. The steps of method 600 are not all-inclusive, and may include other steps not shown.

In step 602, processing system 340 generates a disable download command for a software application operating on external data system 230. The disable download command disables the software application from saving medical records 112 received from medical information card 105. For example, saving may include persistently storing medical records 112 in external data system 230 after the patient's visit with the doctor ends. The disable download command may also preclude copying (e.g., cutting and pasting) medical records 112 for use in another software application. The disable download command may be an option set by patient 150 when initially accessing medical records 112 on medical information card 105. The disable download command may also be set up on a per session (e.g., a doctor visit) or on a per command or exchange basis (e.g., a request for a particular record). The disable download command may also be an option permanently set by a patient on medical information card 105. Disable download commands may also be generated depending on the type of command (e.g., a keyword) issued to medical information card 105.

In step 604, interface system 320 provides medical records 112 to external data system 230. The medical records 112 are provided to external data system 230 with a disable download command. The disable download command is used by software application to preclude saving or copying medical records 112 on external data system 230. External data system 230 uses the disable download command to disable the cut and paste and save functions of the software application during the session.

In step 606, interface system 320 receives data from external data system 230. For example, data may include updates to medical records 112 on medical information card 105, may include new medical records 112 to be saved on medical information card 105, or may include other data to be stored on medical information card 105.

In step 608, processing system 340 stores the received data in storage medium 310. Thus, the patient may build a medical history of medical records 112 stored on storage medium 310 to be provided to a plurality of doctors.

Examples are provided herein to illustrate the operation of medical information card 105. Assume for example that patient 150 visits a doctor. The patient has previously stored medical records 112 on medical information card 105 during a visit with another doctor. The patient now desires to provide the doctor with access to at least a portion of medical records 112. Patient 150 is authenticated using his or her fingerprint to authorize the third party to access medical records 112. Patient 150 holds his or her thumb against medical information card 105. Once patient 150 is authenticated, a wireless or wired connection is activated between external data system 230 and interface system 320.

If patient 150 wants to display his or her medical records 112 related to certain keywords (e.g., heart) on external data system 230, then the patient can say “display all medical information related to heart.” As exemplified herein, a “display” command allows external data system 230 to display medical records 112, but does not allow external data system 230 to persistently store medical records 112 for later use. Processing system 340 may search for medical records 112 related to the patient's heart, and interface system 320 may transmit the selected medical records 112 to external data system 230 with a disable download command. Thus, a software application on external data system 230 may display the selected medical records 112, but may not allow a doctor or other medical professional to save medical records 112. The disable download command may also temporarily disable external data system's 230 cut and paste function for the software application. Thus, the doctor may view selected medical records 112, but may not store the selected medical records 112 for later use.

If the patient wants to download to external data system 230 his or her medical records 112 related to certain organs (e.g., heart), then the patient can say “download all medical information related to heart.” Interface system 320 may transmit the selected medical records 112 to external data system 230 without a disable download command. Thus, software application on external data system 230 may save medical records 112 or may allow a doctor to cut and paste medical records 112 into another software application.

The patient may farther want to display or download all of his or her medical records 112 to external data system 230. The patient may speak “display all medical records.” Likewise, the patient may speak “download all medical records”. As a result, interface system 320 may transmit all of the medical records 112 stored on medical information card 105 to external data system 230. The transmission may or may not be accompanied by a disable download command, depending on the instruction of the patient (e.g., display or download).

The patient may further issue a voice command to processing system 340 instructing medical information card 105 to store data received from external data system 230. External data system 230 may then transmit data to interface system 320 that is stored on storage medium 310.

In the case of an emergency, it may not be possible for the patient to provide access information, such as a password, to access medical records 112. For example, the patient may be unconscious. Medical information card 105 may be adapted so that when the patient's fingerprint is pressed against a fingerprint pad (now shown) of medical information card 105, all of the medical records 112 are downloaded to external data system 230. Thus, emergency personnel at the hospital may use medical records 112 to perform emergency procedures on the patient.

Although specific embodiments were described herein, the scope of the invention is not limited to those specific embodiments. The scope of the invention is defined by the following claims and any equivalents thereof.

We claim:

1. A medical information card for storing medical records of a patient and for controlling access to the medical records by a third party having an external data system, the medical information card comprising:
a storage medium adapted to store the medical records of the patient;
a processing system coupled to the storage medium adapted to receive a request for access to the medical records by the third party and to determine a subset of the medical records that the third party is authorized to access based on the request; and
an interface system coupled to the processing system adapted to exchange the subset of the medical records with the external data system of the third party in response to authenticating the request.

2. The medical information card of claim 1 wherein the request comprises access information of the patient, and the processing system is further adapted to authenticate the patient and to authorize the third party to access the subset of the medical records in response to authenticating the patient.

3. The medical information card of claim 2 wherein the input specifies types of medical records that the third party is authorized to access and wherein the processing system is further adapted to select the subset of the medical records transmitted to the external data system by the interface system based on the input.

4. A medical information card for storing medical records of a patient and for controlling access to the medical records by a third party having an external data system, the medical information card comprising:
a storage medium adapted to store the medical records of the patient;
a processing system coupled to the storage medium, the processing system adapted to receive a request from the patient for access by the third party to tie medical records, wherein the request comprises access information of the patient, and the processing system is further adapted to authenticate the patient based on the access information and to determine a subset of the medical records that the third party is authorized to access based on the request; and
an interface system coupled to the processing system adapted to transmit the subset of the medical records to the external data system of tie third party in response to authorizing the third party.

5. The medical information card of claim 4 wherein the subset of the medical records is determined based on at least one of a category of the medical records, an identity of a doctor creating the medical records, an affliction of the patient, and dates of the medical records.

6. The medical information card of claim 5 wherein the processing system is further adapted to receive a voice command from the patient indicating the category of the medical records.

7. The medical information card of claim 4 wherein the interface system comprises a wireless interface system.

8. The medical information card of claim 4 wherein the access information comprises a password.

9. The medical information card of claim 4 wherein the access information comprises a voiceprint.

10. The medical information card of claim 4 wherein the access information comprises a fingerprint.

11. The medical information card of claim 4 wherein the processing system is further adapted to generate a disable download command for a software application operating on the external data system, wherein the disable download command disables the software application from saving the subset of the medical records received from the interface system.

12. The medical information card of claim 4 wherein the interface system is further adapted to receive data from the external data system, and the processing system is further adapted to store the received data in the storage medium.

13. A method for managing access to a patient's medical records by a third party having an external data system, the method comprising:
storing the medical records of the patient in a portable storage device;
receiving a request from the patient for access by the third party to the medical records, wherein the request comprises access information;
authenticating the patient based on the access information;
determining a subset of the medical records that the third party is authorized to access based on the request; and
transmitting the subset of the medical records to the external data system of the third party.

14. The method of claim 13 wherein the subset of the medical records is determined based on one of a category of the medical records, an identity of a doctor creating the medical records, an affliction of the patient, and dates of the medical records.

15. The method of claim 14 further comprising:
receiving a voice command indicating the category of the medical records.

16. The method of claim 13 wherein the access information comprises a password.

17. The method of claim 13 wherein the access information comprises a voiceprint.

18. The method of claim 13 wherein the access information comprises a fingerprint.

19. The method of claim 13 further comprising:
generating a disable download command for a software application operating on the external data system, wherein the disable download command disables the software application from saving the subset of the medical records.

20. The method of claim 13 further comprising:
receiving data from the external data system; and
storing the received data in the portable storage device.
